(19) United States
(12) Patent Application Publication
(10) Pub. No.: US 2009/0033456 A1
(43) Pub. Date: Feb. 5, 2009

(54) Compact electronic security locker system

(76) Inventors: Gilbert Castillo, Washington, DC (US); Brigham Geurto, Salt Lake Ctiy, UT (US); Marieta Castillo, Washington, MA (US); Ivory Sarcano, Washington, DC (US); John Mahoney, Bethesda, MD (US)

Correspondence Address: HOLLAND & KNIGHT LLP, 2099 PENNSYLVANIA AVE, SUITE 100, WASHINGTON, DC, 20006, US

(21) Appl. No.: 11/882,589

(22) Filed: Aug. 2, 2007

(51) Int. Cl. G06F 7/04

(52) U.S. Cl. 340/5.2; 312/237

(57) ABSTRACT

An embodiment of the present invention provides a compact electronic security locker system that includes an array of lockers, each of which is electronic locked and electronically accessed. One aspect of an embodiment of the present invention allows authorized personnel access to the identification of the person storing an article in a particular locker. In another aspect of an embodiment of the present invention, the storage lockers are arranged in a matrix of rows and columns and are constructed to have a size to accommodate items having a size of common cell phones.

### BACKGROUND OF THE INVENTION

For various reasons many schools prohibit students from bringing cell phones into school. For example, the ringing of cell phones disturbs students taking tests, and cell phones can be misused by students to communicate during tests to exchange answers. Even if cell phones are required to be left in students' lockers, they frequently ring and the ringing disrupts classes.

However, parents would prefer to have their children carry cell phones so that they could keep in touch with their children before or after school. This especially true for students that attend schools in a rough neighborhood where crime in the surrounding neighborhood puts students at risk. In appropriate use of and ringing associated with cell phones are also a problem in many businesses, such as theaters, health clubs and churches. Storage of cell phones is such areas is desirable so long as the space dedicated to such storage is minimized. Thus, there is a need to accommodate the safety needs of students and parents, as well as the every day needs of ordinary business customers, while appropriately addressing the legitimate educational needs of school administrators and the organizational needs of business managers. There is also a need to do so in a compact area so as not to impact existing floor plans or restrict existing traffic patterns.

### SUMMARY OF THE INVENTION

An embodiment of the present invention provides an electronic security locker system that includes an array of lockers each of which is electronic locked and electronically accessed. In a preferred embodiment of the present invention, authorized personnel can have access to the identification of the person storing an article in a particular locker.

### BRIEF DESCRIPTION OF THE FIGURES

FIG. 1 is a perspective view of an embodiment of the present invention.

FIG. 1A is a perspective view of a portion of the FIG. 1 embodiment.

FIG. 2 is a schematic block diagram of one embodiment of circuitry that can be employed in an embodiment such as shown in FIG. 1.

FIG. 3 is a diagram of example circuitry that can be used in embodiments of the present invention.

FIGS. 4A and 4B illustrate one example of circuit boards that can be employed in an embodiment such as shown in FIG. 1.

FIGS. 5A, 5B, and 5C illustrate only one example of logic flow that can be used in an embodiment of the present invention.

### DESCRIPTION OF THE PREFERRED EMBODIMENTS

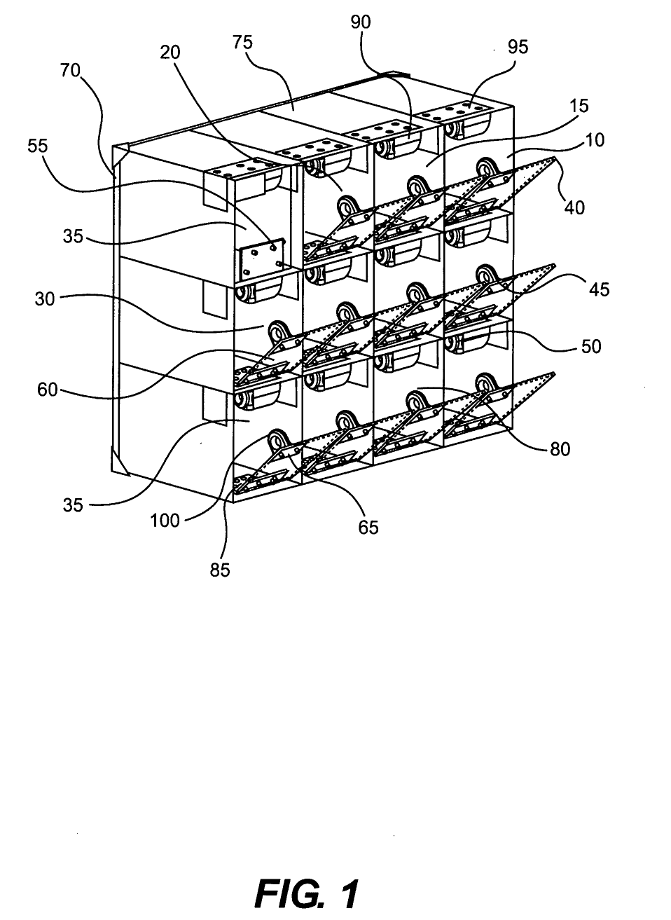

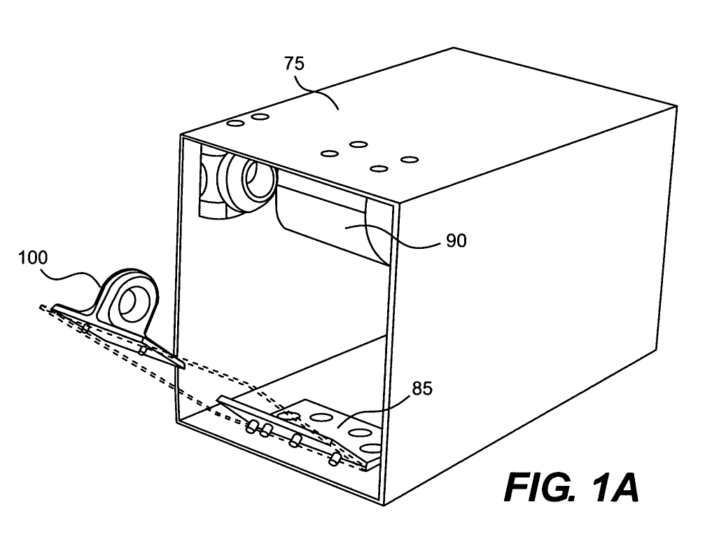

FIG. 1 is a perspective view of an embodiment of the present invention. FIG. 1 illustrates a plurality of storage compartments 10, 15, 20, 25, 30, and 35. In the embodiment shown in FIG. 1, the storage compartments are arranged in a matrix of row and columns. In addition, each of the compartments is dimensioned to accommodate an ordinary cell phone. The arrangement of the storage compartments is shown in FIG. 1 only as an example; the present invention can have storage compartments arranged in any convenient manner. It is preferred that the arrangement of the storage compartments, however, occupy a small areas so as not to occupy a lot of floor space and not to impede foot traffic in the area where the storage compartments are located. In addition, in the FIG. 1 embodiment, each of the storage compartments is constructed and arranged have a size to accommodate a common cell phone. The storage compartments should preferably be constructed of a material that minimizes the opportunity to break into the storage compartments via an outside wall, such as 75 shown in FIG. 1. Those skilled in the art will easily recognize that there are a wide variety of suitable materials, such as wood, metal, or Plexiglas. If the matrix of storage compartments is to be built into a wall or other protective structure, then the outside walls, such as wall 75 need not be as strong as for a stand alone embodiment. The interior walls, such as wall 80, need not be as strong as the wall 75, but can be. Such interior wall should prevent a person from accessing a storage compartment from breaking into adjacent storage compartments.

In FIG. 1, a member 70 restricts access to one end of the compartments. While the FIG. 1 embodiment shows the use of a separate member 70, that blocks access to one end of the storage compartments, that member could be a wall of a building, a wall of another structure or any other suitable member. In addition, each of the storage compartments can alternatively, or in addition to a member 70, have an associated element that restricts access to the corresponding storage compartment. Such element can comprise a wire mesh, or any suitable structure that restricts access to the associated storage compartment so as to substantially prevent removal of an object stored in the associated storage compartment.

The FIG. 1 embodiment also illustrates an example of closure elements, such as doors 40, 45, 50, 55, and 60. In a preferred exemplary embodiment of the present invention, the closure elements comprise a material that allows a person to view the contents of an associated storage compartment. However, it may be desired that the closure elements be opaque. The closure elements 40, 45, 50, 55, and 60 can also be constructed of a wire mesh or any other suitable structure that restricts access to the associated storage compartment so as to substantially prevent removal of an object stored in the associated storage compartment. Some illustrative materials include wood, metal, plastic, vinyl, and Plexiglas.

FIG. 1 also illustrates a plurality of hinge members, such as hinge 85. The hinges operatively couple the closure members, such as elements 40, 45, 50, 55, and 60 so as to restrict access to the associated storage compartment when in a close position. Storage compartment 35 is shown with its associated closure member in a closed position. Any suitable hinging device may be used, and it may be a separate element of an integral part of the closure member and/or the associated storage compartment.

In the FIG. 1 exemplary embodiment described above, each of the storage compartments has associated therewith an electronic lock mechanism, such as electronic lock mechanisms 90 and 95. In one exemplary embodiment of the present invention, the electronic lock mechanisms can comprise a solenoid type lock mechanism. In one such embodiment, the electronic lock mechanism engages an associated closure element when the closure element is in a locked position, such as the closure element associated with storage compartment 35 shown in FIG. 1. In the FIG. 1 exemplary embodiment, the solenoid lock mechanism engages a member 100 associated with corresponding closure members. Referring to FIGS. 1 and 1A, the member 100 can be attached to or integral with the closure member. In addition the embodiment shown in FIG. 1 illustrates the solenoid member positioned within the respective storage compartments, and the members 100 associated with respective closure members. The positions of these two elements can be reversed so that the solenoid member is positioned on or physically associated with, or forming part of the closure member as desired, and the member 100 either attached to or forming a part of the associated storage compartment. It will be recognized by those skilled in the art that any suitable electronic lock mechanism may be used.

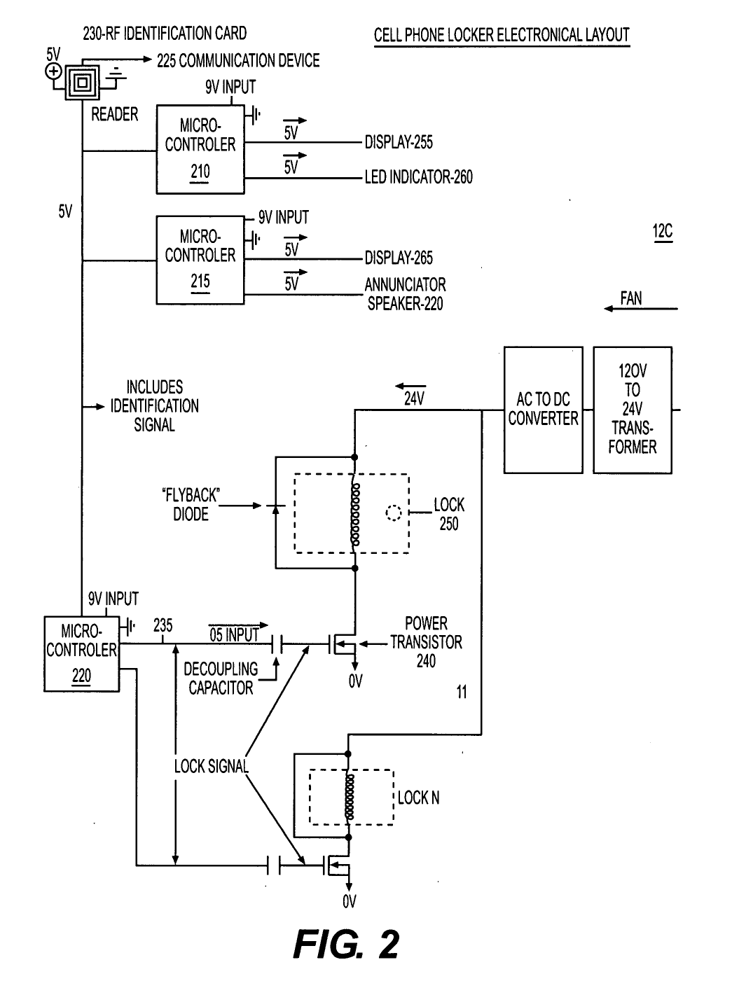

FIG. 2 is a schematic block diagram of one embodiment of circuitry that can be employed in an embodiment such as shown in FIG. 1. In FIG. 2, processors 210, 215 and 220 provide control for the system. While FIG. 2 illustrates three processors, a single processor could also be used. In the example circuitry of FIG. 2, the use of three processors allows simple partitioning of tasks and ease of handling input/output (I/O). As those skilled in the art will recognize, the choice of processor depends upon the particular embodiment as well as other consideration such as cost. One example processor can be a Parallax STAMP II processor.

In FIG. 2, a communication device 225 is operatively connected to the processors. That connection is shown as a direct connection, but could be a wireless connection. The communication device 225 interacts with an identification element 230. Preferably, the identification element 230 uniquely identifies a user of the electronic security locker system. In addition to the following, some examples of communication device 225 include an RF identification card reader, a bar code reader, a proximity fob reciever, or a magnetic stripe reader.

Examples of an identification element 230 include an RF identification card, a magnetic stripe card, or a bar coded card. Alternatively, the communication device and identification element could comprise a single unit, such as an electronic keypad, in which case the identification element would include the keypad that accepts inputs from a potential user of the electronic security locker system. Another example of the communication device and identification element comprising a single unit is a biometric input device. In the case of a biometric input device, the identification element would be the biometric element of the user, such as a physical body part or even the spoken word. Those skilled in the art will recognize that the exact nature of the communication device is not crucial to embodiments of the electronic security locker system of the present invention. It is preferable, however, that the communication device identify the user of the system. In the case of an individual that identification is preferably unique; and in the case of an administrator of the system, that identification could, for example, allow access to any or all of the storage compartments.

In one example embodiment of the electronic security locker system, the communication device 225 comprises an RF identification card reader that interacts with an RF identification card 230 to produce an identification signal. The type of RF identification card and reader is not critical and can be any available RF identification device. In addition, the exact nature of the identification signal is not important to the present invention; it could be a parallel binary signal; a serial binary signal; an encoded or encrypted signal, or other type of signal recognized by one of the processors 210, 215 or 220 in the case of multiple processors or the one processor if only one is used.

Referring to FIG. 2, processor 220 provides a lock signal, which is based on the received identification signal. As an example, the processor 220 generates a lock signal on line 235. The lock signal via circuitry such as the transistor 240, either indirectly such as the example in FIG. 2, or directly serves to cause the exemplary electronic lock mechanism 250 to be energized. In a typical embodiment, energizing a lock such as electronic lock mechanism 250 would cause the associated door, such as door 40 in FIG. 1, to be able to be opened. It will be obvious to one skilled in the art that the default condition of an electronic lock mechanism can be locked or unlocked depending upon the desired state of the storage compartments in the event of no power to the unit. Also, the processor 220 need not directly generate the signal, but can drive, for example a decoder or multiplexer, which in turn would provide a lock signal to circuitry such as 240 (if such circuitry was needed in a particular embodiment).

In the exemplary embodiment shown in FIG. 2, processor 210 recieves information form the communication device 225, and drives a display 255 and an indicator 260. The display can be any display suitable for a particular embodiment and can include devices such as LEDs as well as more complicated displays such as a multi-line LCD display. And, the indicator 260 can be any suitable indicator for a particular embodiment and can include devices ranging from, for example, a simple LED to a more complex indicator, such as, for example, a multi-line LCD display. If desired, the display 255 and the indicator 260 can be implemented separately or in a single display such a multi-line LCD. In fact, the displays in the embodiments of the present invention can comprise a single monitor with the desired information being shown on that monitor, with inputs to the system being received by a keyboard or mouse to activate a desired part of the system or to input information to the system through, for example a touch screen or common menu schemes.

In a similar manner, processor 215 shown in FIG. 2 receives information from the communication device 225 and drives a display 265 and a speaker and/or annunciator 270. The display 265 can be of any type suitable for a particular application and can include displays such as the non-limiting examples discussed with respect to processor 210 above. In the exemplary embodiment shown in FIG. 2, the display shows the number of a particular storage compartment. In the exemplary embodiment shown in FIG. 2, three processors are shown merely for ease of implementation. As those skilled in the art readily recognize, a single processor or any suitable arrangement of processors can be used to implement the desired operations of a particular embodiment.

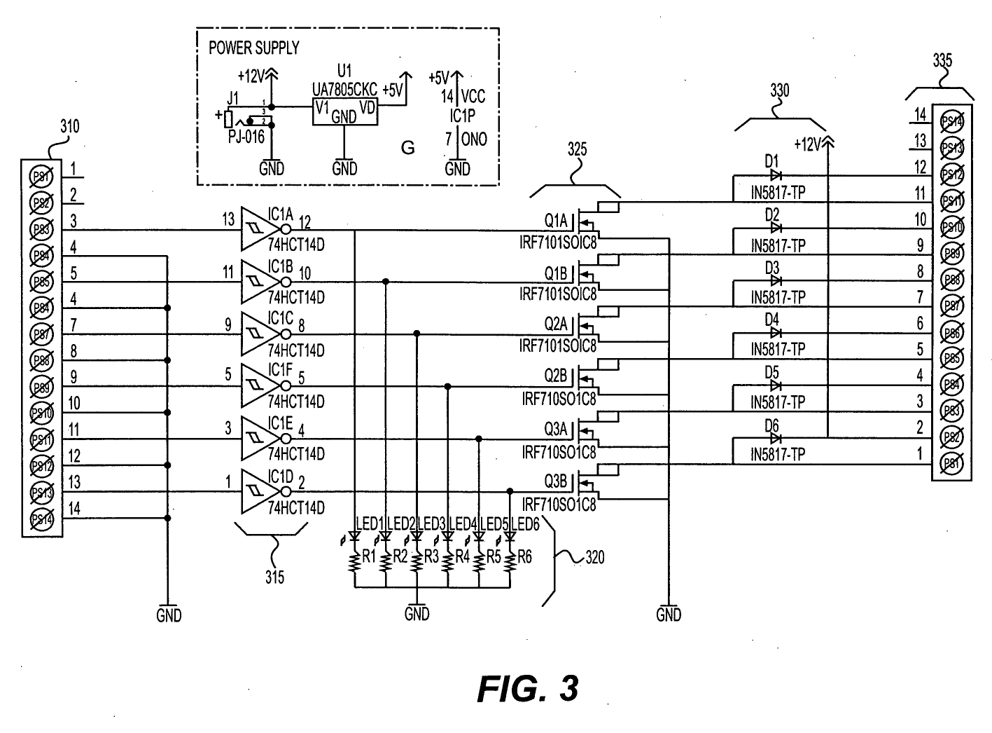

FIG. 3 is a diagram of example circuitry that can be used in embodiments of the present invention. It is expressly intended that the physical hardware and arrangement show in FIG. 3, are for illustrative purposes only and represent only an example of one embodiment of the present invention. All that is needed to practice the present invention is for a processor and/or logic circuitry depending upon the application, to effect an activation of a desired electronic lock mechanism. The circuitry of embodiments of the present invention need not be on multiple boards, and could be on, for example, a single board depending the application.

Referring to the particular example shown in FIG. 3, a terminal strip 310 receives outputs from a processor, such as processor 220 in FIG. 2. In the example embodiment of FIG. 3, the signals from the processor 220, or as mentioned above, in intermediary circuit such as a decoder or multiplexer, are input to corresponding drivers 315. The outputs of the drivers can be used to illuminate an indicator light such as one of the LEDs 320. Such indicators indicate activity on a particular signal line and can be used to determine malfunctions in the system or identify which of the storage compartments should be opened. In the example of FIG. 3, the LEDs 320 also pull-down their respective lines in case an input is left disconnected.

In the FIG. 3 example, the drivers 315 drive corresponding drive transistors 325. In particular applications, the drive transistors 325 may not be needed depending upon the drive capacity of the drivers 315 and the requirements of the electronic lock mechanisms. Referring to FIG. 3, diodes 330 provide a discharge path for a desired electronic lock mechanism and thus protect the drive transistors 330. And, the terminal strip 335 provides a convenient mechanical connection point to connect respective electronic lock mechanisms to corresponding drive transistors 325.

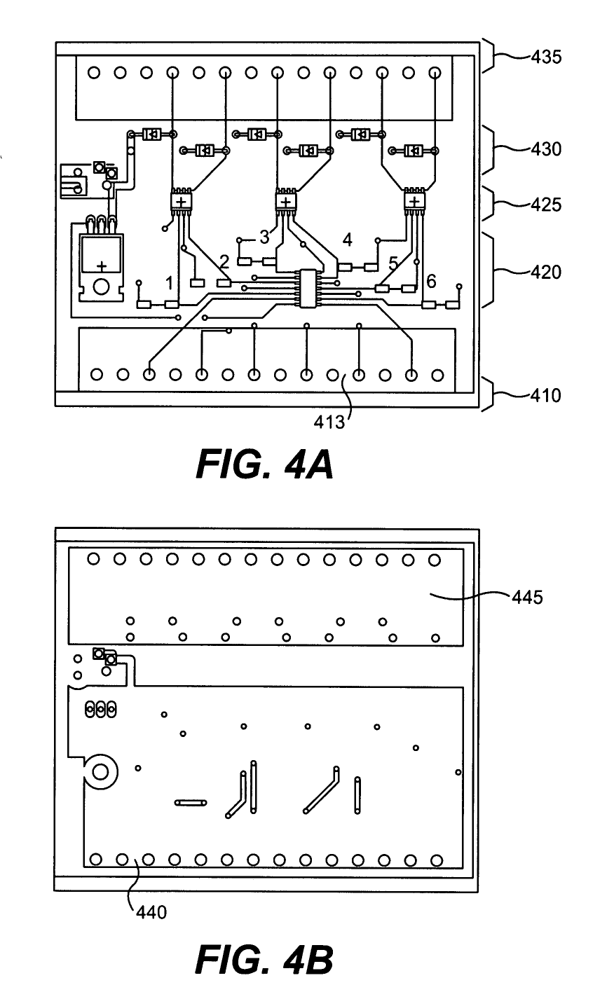

FIGS. 4A and 4B illustrate one example of circuit boards that can be employed in an embodiment such as shown in FIG. 1. As indicated in the figures, FIGS. 4A and 4B are two layers of a circuit board. In the example shown, the layers are on opposite sides of a board, but could be other layers of a multi-layered printed circuit board, preferably adjacent layers. In the example of FIG. 4A, the input terminals 310 shown in FIG. 3 would be electrically connected to terminals 410. The integrate circuit 415 of FIG. 4A embodies the drivers 315 of FIG. 3 and the LEDs 320 of FIG. 3 correspond to the LEDs 420 shown in FIG. 4A. The diodes 330 in FIG. 3 correspond to the diodes 430 of FIG. 4A. And the transistors 325 of FIG. 3 are housed in the integrated circuits 425 of FIG. 4A. Finally, the output terminals 335 shown in FIG. 3 would be electrically connected to the terminals 435 shown in FIG. 4A. In the example shown in FIG. 4B, reference numeral 440 identifies a ground plane, and reference numeral 445 identifies a supply voltage plane, such as 12 volts or 24 volts.

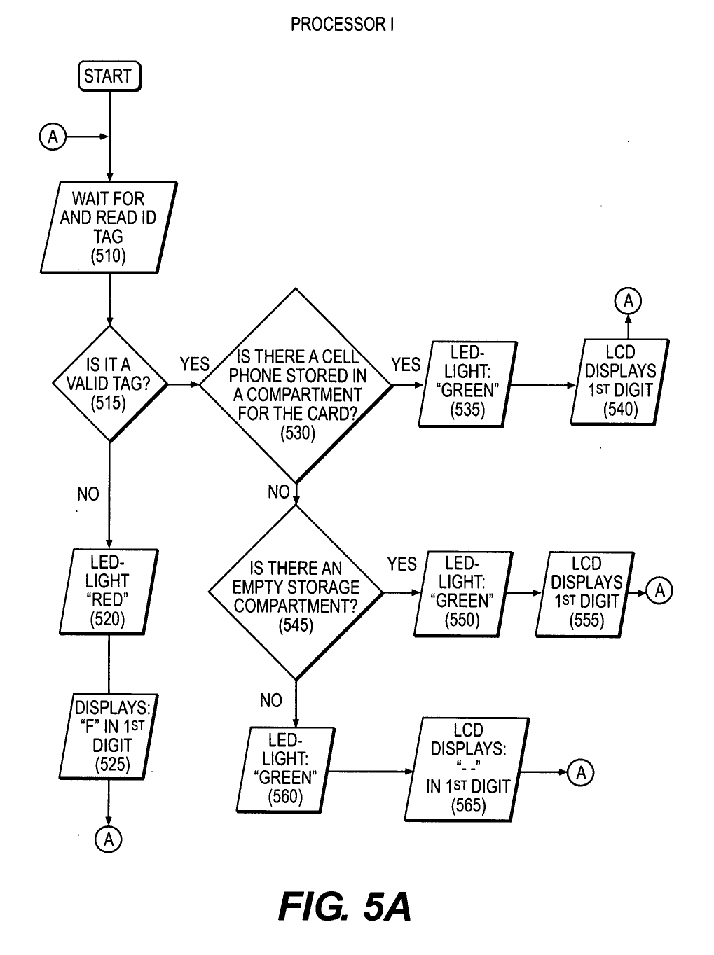

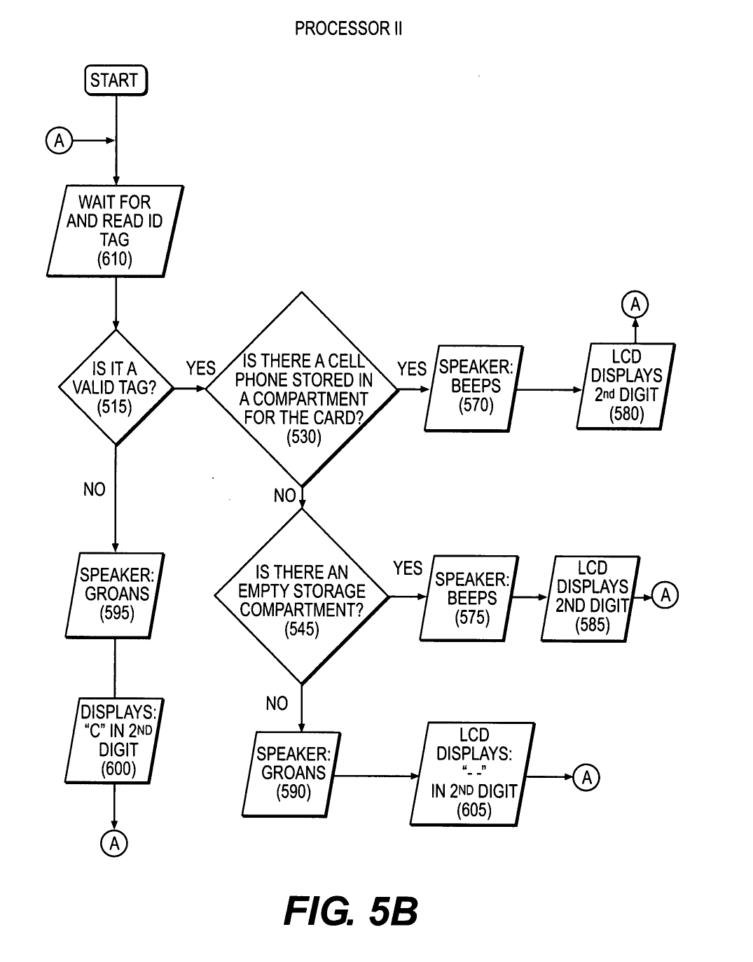

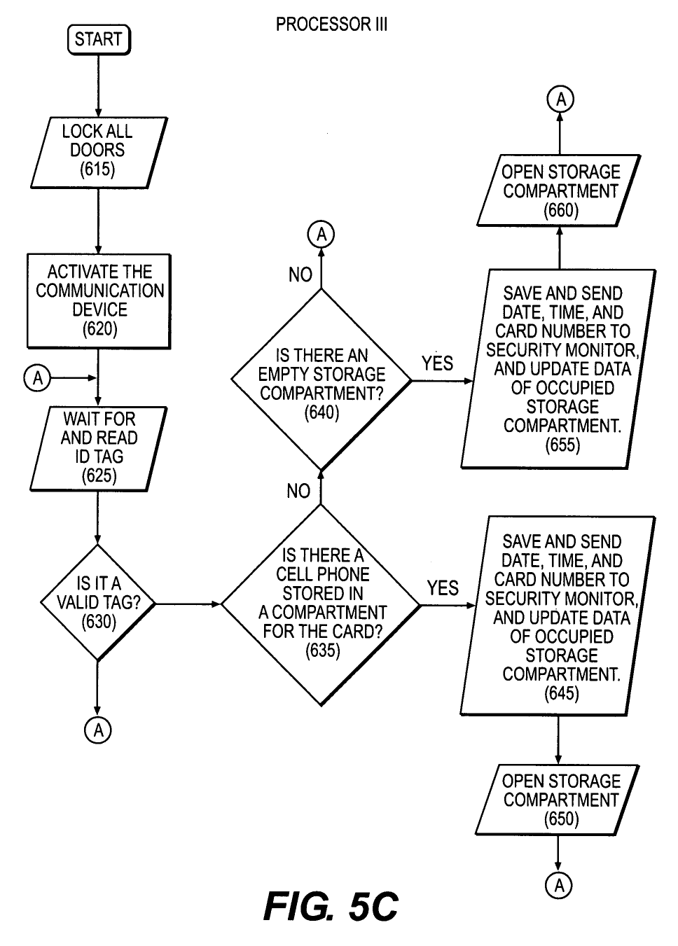

FIGS. 5A, 5B, and 5C illustrate only one example of logic flow that can be used in an embodiment of the present invention. The three FIGS. 5A, 5B, and 5C represent only one example of logic for the three processors shown in FIG. 2. As noted above, the present invention is not limited to three processors and can be embodied in one processor or logic circuitry if desired for a particular application.

In the example of FIG. 5A, at step 510, the processor 210 waits for the communication device 225 to receive information from an identification card 230 shown in FIG. 2. Upon receiving information, at step 515, the processor checks if the information is valid, for example checks if the identification card is a valid card. If the information received from the communication device indicates that the communication card 230 is not a valid card, at step 520 the processor 230 initiates a display indicating that the card is invalid. In the example shown in FIG. 5A, the processor activates a red LED of indicator 260 shown in FIG. 2. As noted above, such indicator need not be an LED, but could be shown on a multi-line display, such as for example, a LCD monitor, which monitors are commonly used with desk top computer systems or used in common bank ATM machines.

As shown in the Example of FIG. 5A, the processor can also check for fake cards. This can be implemented in many ways. One example is a check based on the information provided by the communication device 225, such as comparing the information to a list or data base of valid information such as card numbers and validation dates. In the example of FIG. 5A, the processor initiates a display indicating that the presented identification card is fake or invalid. Processing then returns to step 510 in the example of FIG. 5A.

At step 515 of FIG. 5A, if the information provided by the communication device 225 is determined to be valid, then processing proceeds to step 530 where the processor checks if there is a cell phone stored (or if there is a storage compartment is in use) that is, associated with the information provided by the communication device 225, that is, associated with the identification card 230. Such checking can be implemented in many ways. One example is by checking a list or database of the storage compartments to see if there is a flag or other data indicating or not a storage compartment is in use that is associated with information provided by the communication device 225.

If there is storage compartment is in use that is associated with the identification card 230 presented to the communication device 225, the processor moves to step moves to step 535 and initiates an indication of a positive transaction. In the example of FIG. 5A, the processor initiates the activation of a green LED. As in the above description and in the following discussion, such indication need not be a physically separate indicator or display. As described above and as applicable in the following, it can be on a consolidated display such as an LCD display. Processing then passes to step 540 where the first digit of the storage compartment is displayed. The display of separate digits by separate processors occurs in this embodiment simply for ease of implementation. As noted above, all of the processing can be implemented in a single processor or via logic circuitry or a combination of both. It is not necessary to separately activate a display of separate digits of a storage compartment. The storage compartment number or storage compartment identifier, as well as some or all other indicators, can be presented on a screen as discussed in the above example of a LCD display. As shown in the example of FIG. 5A, processing then returns to step 510 at point A.

In step 530, if there is not a storage compartment is not in use that is associated with the information provided by communication device 225, processing passes to step 545 where the processor checks if there is an available storage compartment. If there is, processing passes to step 550 and, as in the case of step 535, the processor an indication of a positive transaction and then passes to step 555. The above discussion regarding steps 535 and 540 applies equally to steps 550 and 555 and is not repeated here.

In step 545 if there is no empty storage compartments, processing passes to step 560 and initiates an indication of a positive transaction. The discussion regarding step 535 also applies to this step. In this case the positive transaction is, for example, that the identification card 230 is valid, but as indicated in step 565, there is no storage compartment available. In step 565, the processor initiates such an indication, and in the example of FIG. 5A, that indication is via the display of double dashes in a LED display.

The example processing illustrated in the FIG. 5B parallels that shown in FIG. 5A, but illustrates such processing that is performed by processor 215. In addition, the indications of a positive transaction in the example of FIG. 5B are via a speaker in steps 570 and 575. As noted above, these need no be audible indications and can be displayed on a screen, such as a LCD display as discussed above, or via another visual indication. And, in the example of FIG. 5B, in steps 580 and 585, the processor displays the second digit of an identified storage compartment. This is only an example, and as discussed with respect to steps 540 and 555, the information can be displayed in many other ways suitable for a particular application using the present invention.

Also, in the example of FIG. 5B, in steps 590 and 595, the processor indicates a negative transaction. In each case, the indication need not be audible and, as with steps 570 and 575, can be any other suitable indication, if an indication is desired. In steps 600 and 605 of the example of FIG. 5B, the processor displays the second digit of the desired display. And, as noted above such indications need not be a separate physical display. The discussion of such displays provided in connection with FIG. 5A applies to the example of FIG. 5B also. In the example processing illustrated in FIG. 5B, after the noted displays are initiated, processing returns to step 610.

Referring to FIG. 5C, this figure illustrates an example of processing implemented by processor 220. At step 615 shown in FIG. 5C, the processor sets all of the locks in the system to the locked state. This is only an example initialization state, and need not be the same for all storage compartments and the initialization need not be in the locked state. However, it is advisable to have the compartments initially locked after power on because an unscrupulous person need only interrupt power to the system to unlock all of the storage compartments. At step 620, the processor initializes the communication device 225 and then moves to step 625 to wait for an identification card to be presented to the communication device such as discussed with respect to step 510 of FIG. 5A. Upon receiving information form the communication device 225, at step 630, the processor checks if the information is valid, for example checks if the identification card is a valid card. The discussion of such a check with respect to step 515 also applies to the processing associated with step 630. If the processor determines that the identification card is not valid in step 630, processing returns to step 625. On the other hand, if the processor determines that the card is valid, processing moves to step 635. The discussion of the processing associated with steps 530 and 545 also applies steps 635 and 640 and is not repeated here.

If, in step 635, the processor determines that there is a storage compartment in use that is associated with the presented identification card, then processing moves to step 645. In the example of FIG. 5C, at step 645, the processor saves certain information associated with the transaction, such as, for example, the date, the time of day and some data based on the information provided by the communication device 225. Such information could include the identification card number or other identifier for the identification card 220 presented to the communication device 225. This information can also be sent to the system display or to a security monitor, which is not shown in the figures. This allows tracking of access to the storage compartments.

Following the exemplary processing discussed with respect to step 645, processing passes to step 650, where the processor initiates opening of the desired storage compartment. The initiation of such opening can include, for example, activating one of the processor's output lines associated with the desired storage compartment, or the sending of appropriate data to a decoder which in turn activates a line associated with the desired storage compartment. Following the activation process of step 650, processing returns to step 625.

If, in step 640, the processor determines that there is an available empty storage compartment, processing moves to step 655. In the exemplary processing shown in FIG. 5C, step 655 includes processing to save certain information associated with the transaction, such as, for example, the date, the time of day and some data based on the information provided by the communication device 225. Such information could include the identification card number or other identifier for the identification card 220 presented to the communication device 225. This information can also be sent to the system display or to a security monitor, which is not shown in the figures. This allows tracking of access to the storage compartments and such processing is similar to that discussed with respect to step 645. Although in step 645, the saved information indicates that there is not a storage compartment associated with the identification card 220 presented to the communication device 225; while in step 655, the saved information indicates that there is a storage compartment in use associated with the identification card 220 presented to the communication device 225. Following the processing of step 655, processing moves to step 660, where the processor initiates the opening of the desired storage compartment. As discussed above, the initiation of such opening can include, for example, activating one of the processor's output lines associated with the desired storage compartment, or the sending of appropriate data to a decoder which in turn activates a line associated with the desired storage compartment. Following the activation process of step 660, processing returns to step 625.

What is claimed is:

1. An electronic security locker system comprising:
a plurality of storage compartments, each having two ends with one of the ends being obstructed to prevent access to the corresponding storage compartment;
a plurality of electronic lock mechanisms, each respectively associated with a corresponding one of the storage compartments and operative to unlock in response to a corresponding lock signal;
a plurality of closure elements, each respectively associated with a corresponding one of the storage compartments and positioned at the other end of the corresponding storage compartment so as to operatively coupled with a corresponding one of the electronic lock mechanisms when such mechanism is locked;
a communication device operatively coupled to interact with an identification element and to provide an identification signal based on the interaction; and
a controller operatively coupled the plurality of electronic lock mechanisms, and constructed and arranged to receive the identification signal and to provide a corresponding lock signal based on the identification signal.

2. An electronic security locker system according to claim 1, wherein the communication device includes an rf ID device.

3. An electronic security locker system according to claim 1, wherein the communication device includes a bar code reader.

4. An electronic security locker system according to claim 1, wherein the communication device includes a biometric device.

5. An electronic security locker system according to claim 1, wherein the plurality of storage compartments are arranged in a matrix of rows and columns.

6. An electronic security locker system according to claim 5, wherein each of the plurality of storage compartments is constructed and arranged have a size to accommodate a common cell phone.

7. An electronic security locker system according to claim 1, wherein the controller is constructed and arranged to store an identity of a user based on the identification signal.

8. An electronic security locker system according to claim 1, wherein the controller is further constructed and arranged to provide the identity in response to authorized inquiries.
